(19) United States
(12) Patent Application Publication
(10) Pub. No.: US 2020/0319992 A1
(43) Pub. Date: Oct. 8, 2020

(54) PREDICTING DEFECTS USING METADATA

(71) Applicant: Red Hat, Inc., Raleigh, NC (US)

(72) Inventors: Alexander Braverman Masis, Raanana (IL); Boaz Shuster, Raanana (IL)

(21) Appl. No.: 16/374,217

(22) Filed: Apr. 3, 2019

(51) Int. Cl. G06F 11/36; G06N 5/04

(52) U.S. Cl. CPC G06F 11/3608; G06F 11/3664; G06N 5/048

(57) ABSTRACT

Systems, methods, and machine-readable instructions stored on machine-readable media are disclosed for receiving metadata associated with a source code. Prior to testing the source code, the metadata associated with the source code is analyzed to predict a likelihood of success of the testing. The source code is then tested based on the predicted likelihood of success.

### FIELD OF DISCLOSURE

The present disclosure generally relates to data processing, and more particularly to error detection.

### BACKGROUND

Software testing provides information about the quality of a software product. Test techniques include the process of executing a program or application to find software bugs, errors, and other types of defects that may cause software to respond incorrectly to inputs, generate incorrect outputs, fail to perform its function, etc.

One type of testing, commonly referred to as white-box testing, tests the internal structures or workings of software using test cases designed to exercise paths through the source code. For example, code coverage testing may be performed to verify that each function, subroutine, statement, branch, or condition in the source code executes correctly. However, such detailed testing may require a high amount of computer and human resources. Thus, it is desirable to develop improved testing techniques that can perform software testing in a more efficient way.

### SUMMARY

A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system including: a non-transitory memory, and one or more hardware processors coupled to the non-transitory memory to execute instructions from the non-transitory memory to perform operations including: receiving metadata associated with a source code; prior to testing the source code, analyzing the metadata associated with the source code to predict a likelihood of success of the testing; and testing the source code based on the predicted likelihood of success. Other examples of this aspect include corresponding computer systems, apparatus, and computer programs recorded on one or more computer storage devices, each configured to perform the actions of the methods.

One general aspect includes a method including: receiving metadata associated with a source code; prior to testing the source code, analyzing the metadata associated with the source code to predict a likelihood of success of the testing; and testing the source code based on the predicted likelihood of success. Other examples of this aspect include corresponding computer systems, apparatus, and computer programs recorded on one or more computer storage devices, each configured to perform the actions of the methods.

One general aspect includes a non-transitory machine-readable medium having stored thereon machine-readable instructions executable to cause at least one machine to perform operations including: receiving metadata associated with a source code; prior to testing the source code, analyzing the metadata associated with the source code to predict a likelihood of success of the testing; and testing the source code based on the predicted likelihood of success. Other examples of this aspect include corresponding computer systems, apparatus, and computer programs recorded on one or more computer storage devices, each configured to perform the actions of the methods.

### BRIEF DESCRIPTION OF THE DRAWINGS

FIG. 1 is an organizational diagram illustrating a system for predicting the likelihood of success of a change involving a piece of source code.

FIG. 2 is a flow diagram illustrating a method for using metadata to predict the likelihood of success of a change involving a piece of source code.

FIG. 3 is an organizational diagram illustrating a system for generating a predicted likelihood of success using a machine learning function.

FIG. 4 is an organizational diagram illustrating a system for generating a further predicted likelihood of success using additional machine learning functions.

### DETAILED DESCRIPTION

In the following description, specific details are set forth describing some examples consistent with the present disclosure. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional.

Software testing involves creating test cases comprised of inputs, software code to be tested, and expected outputs. A test program or a test harness may be used to pass inputs into the test code and to determine if the test code output is within expectations. Software testing may be performed according to a wide range of methodologies. In some examples, linear testing may be used to singularly test every change, and each change which passes the applicable test may be merged before further changes are applied. While linear testing may be thorough, it is also time-consuming and resource-intensive. Another example of a testing method is combinatorial testing, which may be used to reduce the number of tests by packing a plurality of changes into a test unit and testing the unit as a whole. In some examples, combinatorial testing may begin with testing one change at a time, and as more and more of the individual tests succeed, the combinatorial tester may create different combinations and different sets of successful changes with the goal of producing the set with the highest number of successful changes. As a further example, binary searching may be used to more quickly narrow down a successful combination of changes by testing the set of changes against an ordered array of comparable objects. For example, an input change may be tested against a comparable object by inserting the change into a position in the array and determining if the result of the input at the insertion point is higher or lower than the expected output. If the result is higher, then the remaining higher positions are split into two and the input reinserted into one of the higher positions. The inserting, determining, and reinserting are repeated until an insertion point for the change is found that meets an expected output.

As can be seen, software testing is highly resource intensive. At the same time, software testing is also crucial to ensuring that errors are caught before a production version of a software is launched. To make software testing more efficient, predictive techniques may be used to determine if a change is likely to be successful or not. In some examples, such predictive techniques may be based on a detailed analysis of the code changes to be tested. An analyzer may inspect a portion of the source code to be tested or test code itself to determine if it contains errors that would lead to compilation errors or any other types of coding errors, or if it contains code that is likely to lead to errors because of its similarity to problematic code reported in prior build logs. Such analysis is code-centric, i.e., it relies on an analysis of the code itself. Such analysis may also be called a functional analysis, as it is based on the code's operational or functional content.

Metadata-based analysis, described more fully herein, stands in stark contrast to functional analysis. To analogize, whereas functional analysis may require carefully proofreading a book from cover-to-cover to determine that there are not any misplaced sentences or missing paragraphs, metadata-based analysis may make the same determination without necessarily having even read the book. After all, metadata is the data or information that provides information about other data. More succinctly, metadata is data about data. Thus, the focus of metadata-based analysis is not on directly finding errors in the data, but on inferring the presence or absence of errors based on other information associated with the data. For example, a metadata analyzer may store in a data structure metadata about a book, such as the book's author, publisher, edition number, year of print, genre, and so forth. The metadata analyzer may also store in corresponding entries in the data structure a variety of different types of errors detected in the book (e.g., by a person or by a computer program). Then, based on the strength of the correlation of the individual metadata parameters or a combination of the metadata parameters to a particular error type or a combination of error types, the metadata-based analyzer may be able to accurately predict the likelihood that the analyzed errors would appear in a new book sharing the same or similar traits of the books previously analyzed, e.g., a new book written by the same author and published by the same publisher, but in a different genre.

Different types of metadata exist. For example, descriptive metadata includes metadata that describe a resource so that it may be discovered and identified, and includes elements such as a file name or the author of the file. Structural metadata includes metadata that describes how compound data is organized, such as the headings in a table. Administrative metadata includes metadata that provide information about resource management, such a file's creation or modification date, file size, and file type or extension. Reference metadata includes metadata that describe the contents and quality of test data. Reference metadata may be subdivided into conceptual metadata, methodological data, and quality metadata. Conceptual metadata describe the testing concepts used and how the concepts will be practically implemented, thereby allowing users to understand what the test is about, what the test is measuring, and the appropriateness of the test vis-à-vis the source code to be tested. Methodological data describe the testing methods and procedures used to test the source code, including the inputs and expected outputs. Quality metadata describe quantitatively and qualitatively the results of the testing, including whether the test was successful or not, reviewers' comments, error codes, etc.

Thus, metadata contain a wealth of information about the source code that is to be tested, making metadata potentially useful for predicting success of the test code. In contrast to predicting success using functional analysis of the contents of the source code itself, predicting success using metadata is, by definition, not focused on any operational or functional aspects of the test code, but is instead focused on the rest of the data about the test code. For example, the author of the test code, the identities of the reviewers reviewing the test code, the job title or seniority of the author and the reviewers, the number of lines of code that the author and the reviewers have respectively committed and reviewed, and other metadata associated with the test code, can be just as enlightening and predictive of errors as trawling through lines of code to detect a missing brace. By basing its analysis on metadata associated with the source code rather than the source code itself, a metadata-based analyzer is able to make success predictions without knowing anything about the code's instructions or what it is supposed to do, which significantly reduces the complexity of the analyzer and speeds up the testing process.

Further, the accuracy and speed of metadata-based analyzers may be augmented by machine learning. For example, machine learning techniques such as linear regression or linear networks may be used to train the analyzer. In some examples, training includes selecting one or more of the most impactful parameters from a set of metadata. In some examples, combinatorial approaches, similar to the techniques used in combinatorial testing, may be used to identify combinations of the most impactful metadata parameters. For example, changes authored by A and reviewed by B may have a high historical success rate, while changes authored by C and reviewed by D may have a low historical success rate. Nevertheless, an entirely different combination may have a still higher success rate, e.g., changes having less than 100 lines of code that were authored by A. While the examples here describe two-parameter combinations, the analyzer may well analyze combinations comprising any number of parameters. Additionally, ensemble machine learning techniques such as random forest may be used to select and group the most impactful parameters.

In some examples, training includes calibrating the sensitivity of the analyzer to variations in the metadata by repeatedly feeding the analyzer with a variety of training sets based on historical data and historical results. In some examples, the analyzer's accuracy may be validated by feeding the analyzer with a combination of previously-fed training sets and fresh data.

After training, the analyzer may be fed with live test code. Based on the metadata associated with the live test code, the analyzer outputs a probability of success. In some examples, the analyzer may also perform functional analysis, and may combine its functional analysis with metadata analysis to generate a composite probability of success. In generating the composite probability, different weights may be applied to functional analysis as to metadata analysis. Nevertheless, in some examples, the probability of success is based only on one of functional analysis or metadata analysis.

The analyzer may proceed to rank the changes with the highest probability of success, which rank may be used to determine the order of testing by a tester. In some examples, the analyzer sends the changes in ranked order. For instance, changes which have the highest rank, and thus the highest probability of success, may be sent first to the test program, followed by changes with lower ranks. In some examples, the changes are not sent by the analyzer to the tester in ranked order. Nevertheless, the test program may still receive the ranking information and optimize its testing sequence based on the ranking information. In some examples, the average likelihood of related changes, such as those that are to be merged into the same branch, is calculated and ranked as a group. The analyzer may send the groups of related changes to the tester based on the group ranking, or the tester may optimize its testing sequence based on the group ranking.

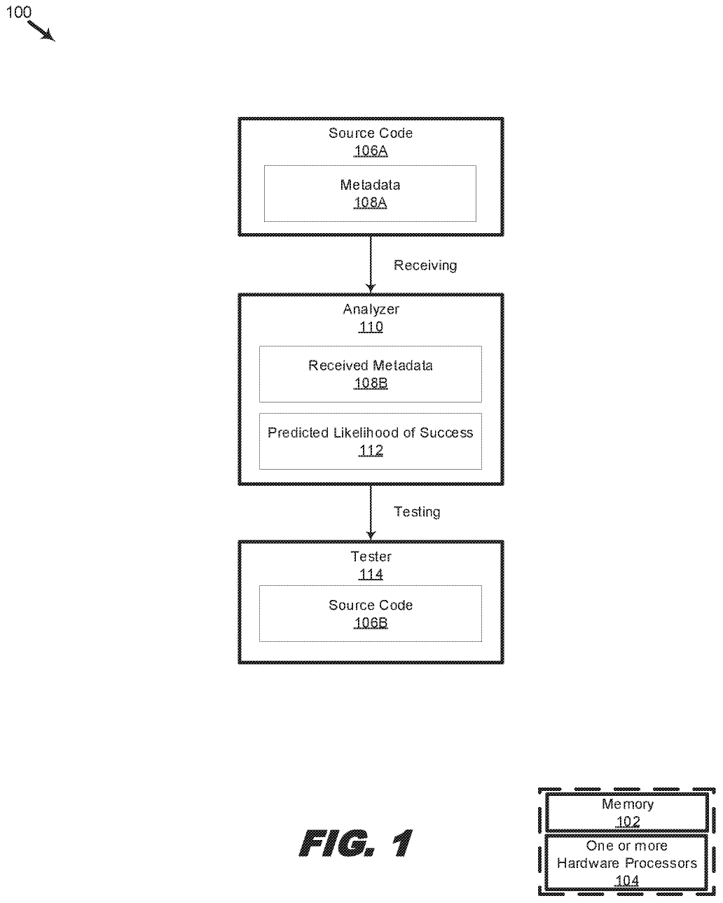

FIG. 1 is an organizational diagram illustrating a system for using metadata to predict the likelihood of success of a change involving a piece of source code, in accordance with various examples of the present disclosure. The system 100 includes a non-transitory memory 102 and one or more hardware processors 104 coupled to the non-transitory memory 102. In the present example, the one or more hardware processors 104 executes instructions from the non-transitory memory 102 to perform operations for: receiving metadata 108A associated with a source code 106A; prior to testing the source code 106A, analyzing the metadata 108A associated with the source code to predict a likelihood of success 112 of the testing; and testing the source code 106A based on the predicted likelihood of success 112.

Each of the one or more hardware processors 104 is structured to include one or more general-purpose processing devices such as a microprocessor, central processing unit (CPU), and the like. More particularly, a processor may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some examples, each processor is structured to include one or more special-purpose processing devices such as an application specific integrated circuit (ASIC), a field programmable gate array (FPGA), a digital signal processor (DSP), network processor, and so forth. The one or more processors execute instructions for performing the operations, steps, and actions discussed herein.

A non-transitory memory 102 is structured to include at least one non-transitory machine-readable medium on which is stored one or more sets of instructions (e.g., software) including any one or more of the methodologies or functions described herein. The non-transitory memory may be structured to include one or more of a read-only memory (ROM), flash memory, dynamic random access memory (DRAM) such as synchronous DRAM (SDRAM), double data rate (DDR SDRAM), or DRAM (RDRAM), and so forth), static memory (e.g., flash memory, static random access memory (SRAM), and so forth), and a data storage device (e.g., hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read). Accordingly, any of the operations, steps, and actions of the methods described herein may be implemented using corresponding machine-readable instructions stored on or in a memory that are executable by a processor.

The system 100 includes a bus or other communication mechanism for communicating information data, signals, and information between the non-transitory memory 102, the one or more hardware processors 104, and the various components of system 100. For example, the various components may include a data storage device, which may be local to the system 100 or communicatively coupled to the system 100 via a network interface. Components may further include input/output (I/O) components such as a keyboard, mouse, touch interface, and/or camera that process(es) user actions such as key presses, clicks, taps, and/or gestures and sends a corresponding signal to the bus or other communication mechanism. The I/O component may also include an output component such as a display.

In some examples, a user may use the I/O component to command the system 100, via a user interface such as a graphical user interface, a command line interface, or any other interfaces a user may use to communicate with system 100, to directly or indirectly cause source code 106A and associated metadata 108A to be stored on the non-transitory memory 102. For example, a user may retrieve the source code 106A and associated metadata 108A from a repository over a network, such as a local area network or the internet. In some examples, the metadata 108A includes metadata that was provided to the system 100, e.g., from an external source, as well as metadata that is locally created by the system 100, e.g., after processing the source code 106A or the metadata 108A. In some examples, processing may include counting the number of lines in source code 106A and storing the result in metadata 108A. Other processing steps may be performed to obtain more metadata parameters, such as the author name, author experience, reviewer name, and other metadata parameters further described herein.

A user may use an I/O component to cause the source code 106A and/or metadata 108A to be analyzed by analyzer 110. In some examples, this step may be automated as part of a script or other programming instructions to run the received source code 106A and/or metadata 108A through analyzer 110. Analyzer 110 may be software stored on non-transitory memory 102 containing instructions to analyze the metadata 108A and generate a predicted likelihood of success 112. Metadata 108B may refer to the received form of metadata 108A by the analyzer 110 and/or metadata 108A that has been further processed by the analyzer 110. Analyzer 110 may be a cloud-based software distributed over many systems, each of which includes one or more hardware processors coupled to a non-transitory memory similar to 102 and 104 described above. Thus, analyzer 110 may utilize virtualized or distributed computing and be accessible to a user over a network.

In some examples, the analyzer 110 is set to be used by default to predict whether source code 106A is likely to generate errors in testing before source code 106A is actually tested by a testing program, such as tester 114. Tester 114 may be any testing program designed to test software, for example, by manually or automatically applying test cases with inputs, expected outputs, and a test procedure. Tester 114 may be any kind of software testing tool, suite, platform, pipeline, program, software, mocker, object mocker, application programming interface (API) tester, performance tester, validator, test automator, or any other type of software for testing software code. In some examples, the analyzer 110 and the tester 114 may be part of the same program, software, executable, binary, library, container image, virtual image, or module. In some examples, the analyzer 110 and the tester 114 may be different programs, software, executables, etc. In some examples, the analyzer 110 may be used situationally, e.g., when the tester 114 is busy, or when the resource cost of running the metadata-based analysis is cheaper than actually testing the source code 106A using the tester 114. In some examples, a prediction may be made based on a history of costs as to what the cost of running the metadata-based analysis and testing by the tester 114 will be. If the predicted cost of running the metadata-based analysis is low enough, e.g., below a threshold cost of testing the source code 106A by the tester 114, then the analyzer may perform the analysis. For instance, if the cost of running the metadata analysis is 1 second but the cost of testing the source code is 20 seconds, and if the cost threshold to proceed with metadata analysis is set to 10%, then metadata analysis will proceed since in this case the cost of metadata analysis is 5% which is below the 10% threshold. However, if the cost of running the metadata analysis were 5 seconds instead, then metadata analysis would not proceed since the cost of metadata analysis is 25%, which is above the 10% threshold.

In some examples, after the analyzer 110 has completed its analysis and predicted a likelihood of success 112, a tester 114 may test the source code 106A. In some examples, testing may be based on the predicted likelihood of success 112. In some examples, if the predicted likelihood of success 112 is below a threshold, the source code 106A may not be tested, and may be returned to the author or reviewers for further review without testing. In some examples, system 100 may be used to optimize the sequence of source codes to be tested. For instance, the source code with the highest likelihood of success 112 may be tested before other source codes with lower likelihoods of success. Source code 106B may refer to source code 106A after testing by tester 114.

In more detail about the analyzer 110 and the metadata parameters it uses for its analysis, metadata 108B may include different types of metadata, including descriptive metadata, structural metadata, administrative metadata, and reference metadata. In some examples, metadata 108B further includes an author name, author experience, reviewer name, number of reviewers, reviewer experience, file name, file type, number of lines or changed lines, reviewer sentiment, time of review, time of writing, number of failures, and failure type.

Author and reviewer experience may be measured by the number of commits that the author has merged and the number of merged commits that the reviewer has reviewed. Experience may also be measured by a number of years of experience, the number of lines of code merged, the number of code reviews performed, etc. Authors and reviewers that have more experience may be assigned a higher score than authors and reviewers with less experience. Such scores may be used in determining the likelihood of success 112 of the source code 106A in testing.

File name and file type may be part of a “file” tuple that includes in the first part the name of the file containing or assumed to contain the source code 106A, and in the second part the extension of the file. For example, file extensions may include .py, .go, or .c, or other file extensions corresponding to the programming environment in which source code 106A is written. Such file extensions may be categorized under a “code” file type. Other file extensions, such as .md or .txt associated with text editors may be categorized under a “document” file type. As a further example, extensions such as .ini or .yaml associated with configurations may be categorized under a “configuration” file type. Some file types, such as “document” file types, are known not to contain any source code. However, before the file type is determined, it is assumed that the file which an author or a developer wishes to commit to a project includes source code 106A. If the file is of a type that does not contain source code 106A, then the file may not even be analyzed or tested as described herein. Nevertheless, for files that may contain source code such as “code” or “configuration” file types, scores may be assigned based on the file's extension or the file's type. For example, .txt extensions may have a higher score than .py extensions, while “document” type files may have a higher score than “code” type files. Such scores may be used in determining the likelihood of success 112 of the source code 106A in testing.

The number of lines may refer to a count of all lines of source code 106A, and the number of changed lines may refer to a count of all lines of source code 106A that have been changed, for example, by an author. In some examples, the number of changed lines in source code 106A may be expressed as a fraction or percentage of the total number lines in source code 106A. Scores may be assigned based on the number of lines of code in source code 106A or the number of changed lines in source code 106A. A higher score may be assigned if fewer lines of code are being changed, or if source code 106A has a low line count. Such scores may be used in determining the likelihood of success 112 of the source code 106A in testing.

Reviewer sentiment may include a quantitative rating or qualitative commentary entered by reviewers after reviewing the source code 106A. The commentary may be positive or negative. Quantitative ratings above a threshold value may be considered positive, while ratings below the threshold may be considered negative. Positive ratings may be assigned a score such as 1, while negative ratings may be assigned a score such as 0. In some examples, reviewer sentiment is used to determine whether source code 106A is likely to succeed in testing. For instance, the reviewer sentiment score may be taken into account in the calculating the likelihood of success 112. With qualitative commentary, machine learning functions may be used to classify the commentary as positive or negative. For example, a machine learning function, such as a decision tree, may be trained using sets of data previously categorized as positive or negative. The machine learning function may learn a pattern of classification from the training sets, which pattern may be based on the occurrence and order of certain key words, such as “good,” “excellent,” “needs work,” “poor,” “fix,” or any number of adjectives or other information contained in the qualitative commentary. The machine learning function's ability to accurately classify the reviewer sentiment as positive or negative may be validated against other pre-classified data sets that were not part of the training set. After successful validation, the machine learning function may be used to determine whether a reviewer's sentiment associated with source code 106A is positive or negative. If the reviewer's qualitative commentary is determined to be positive by the machine learning function, then the positive qualitative commentary is assigned a certain score. Similarly, if the reviewer's qualitative commentary is determined to be negative by the machine learning function, then the negative qualitative commentary is assigned a different score. Such scores may be used in determining the likelihood of success 112 of the source code 106A in testing.

The time of review and the time of writing may refer to the times at which the source code 106A was respectively reviewed and written. For example, the source code 106A may be reviewed or written at 9 a.m. The time of review or writing may be based on the time that the reviewer or author performed an action on the file containing the source code 106A, such as the time that the reviewer or author opened the file, the time that the reviewer or author last saved the file, the time that the reviewer or author last modified the file, the time that the reviewer last entered his or her comments, the time that the author last entered changes to the source code 106A, the time that the reviewer or the author uploaded the file to a server such as an online repository (e.g., GITHUB) or to an online development pipeline (e.g., REDHAT OPENSHIFT), etc. In some examples, the time of review or writing is selected from among the many time-related metadata parameters exemplified above according to a pre-defined hierarchy. For instance, if both the upload time and the last modified time are available, then the upload time may be selected as the time of review according to the hierarchy.

The time of review or writing may also refer to a time of day, such as dawn, morning, noon, afternoon, evening, dusk, night, midnight. In some examples, the time at which the relevant reviewer's or author's action occurred may be converted into a time of day by the system 100, e.g., if the reviewer submitted his review of source code 106A at 0800 hours, which falls within the hours of 0700 hours and 1200 hours defined as “morning,” the time of review may be recorded as “morning” instead of 0800 hours. Nevertheless, in some examples, the time of review is recorded as 0800 hours. In some examples, the time of day that source code 106A is reviewed may have a strong correlation with the likelihood of success 112. For example, source code 106A reviewed at dawn may, for whatever reason, have a higher likelihood of success than source code 106A reviewed at dusk. Accordingly, each hours and minute of the day, and each of the different times of day, may be assigned their own scores. Such scores may be used in determining the likelihood of success 112 of the source code 106A in testing.

The number of failures may refer to the number of times that the source code 106A has been modified and failed. For example, the source code 106A may be a function including several elements. The first element of the function may have been modified in a first modification, a second element in a second modification, and a third element in third modification. If each modification led to a test failure or an error during testing of the function, the number of failures would be three. In other examples, the number of failures may refer to the number of times that a specific element of source code 106A has been modified and failed. Thus, under this definition, the number of failures (for elements 1, 2, and 3) would be 1. Scores may be assigned based on the number of failures. For example, a high number of failures may be assigned a low score, while a high number of failures may be assigned a high score. The scores may be used in determining the likelihood of success 112 of the source code 106A in testing.

The failure type may generally refer to two types of failures: Type 1 failures are failures related to changes in source code 106A. Type 2 failures are failures not related to changes in source code 106A. Natural processing or information retrieval algorithms, such as term frequency-inverse document frequency, n-gram, bigram, or bag-of-words, may be used to parse error logs to determine whether or not the failures associated with source code 106A were caused by functional changes in the source code 106A. For example, certain words or error codes in the error log may be associated with source code-related failures, and the frequency with which those words and error codes appear in the relevant portion of the error log pertaining the source code 106A may be used to determine whether or not the error was a Type 1 failure or a Type 2 failure. Additionally, the reviewer's comments may also be parsed using the natural processing or information retrieval algorithms to determine the same. In some examples, machine learning techniques such as decision tree, k nearest neighbors, or random forest, are used instead of or in addition to the natural processing or information retrieval algorithms to determine if the error was a Type 1 or Type 2 failure. Different scores may be assigned to Type 1 failures and Type 2 failures. In some examples, Type 1 failures are assigned a lower score than Type 2 failures, whereas in other examples it is the reverse. The scores may be used in determining the likelihood of success 112 of the source code 106A in testing.

Thus, metadata 108B may include each of the metadata parameters described above. In addition, metadata 108B may include any other metadata parameters not described above, but which fall under the definition of metadata as described herein, which would include any new metadata parameters generated by the system 100, e.g., by processing the metadata 108A or the source code 106A. Any or all of the metadata parameters in metadata 108B may be analyzed by the analyzer 110 to generate a predicted likelihood of success 112. In some examples, the predicted likelihood of success 112 is based on a scoring system of each of the individual metadata parameters in metadata 108B. The analyzer 110 may score some, none, or all of the metadata parameters in metadata 108B, and the scoring system may be kept consistent across each of the metadata parameters, for example, each metadata parameter may have a maximum score of 1 and a minimum score of 0. The scores may be related to the rate, frequency, or probability with which the metadata parameter or a combination of the metadata parameters correctly predicts a testing result of previously tested source code. For example, the analyzer 110 may analyze a number of previously tested source codes using a combination of metadata parameters, such as author name, author experience, and the number of reviewers. Using these three metadata parameters, the analyzer 110 may correctly predict the outcome of the testing of the source codes, for example, 80% of the time. However, using a different combination of metadata parameters, the analyzer 110 may only have a 60% accuracy. In some examples, the accuracy may be converted to a score, such as 0.8 or 0.6.

In some examples, the score of each metadata parameter or combination of metadata parameters may further be weighted based on the relative importance or impact of each metadata parameter to the likelihood of success 112. For example, if it is determined based on prior data that the identity of the author is highly determinative of the likelihood of success 112 of the source code 106A in testing, then the “author's name” metadata parameter may be assigned a higher weight than other less critical parameters. In some examples, the predicted likelihood of success 112 is determined by the sum of the weighted scores of the metadata parameters, i.e., multiplying the individual scores of each metadata parameter by their assigned weights to obtain the weighted scores of each metadata parameter, then summing the weighted scores.

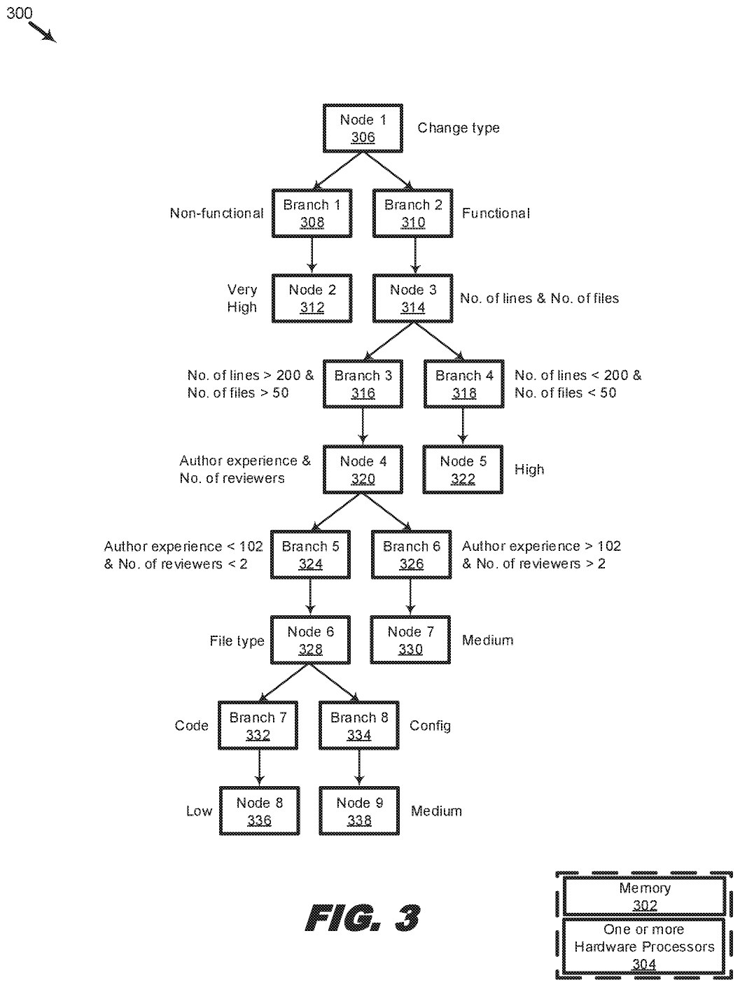

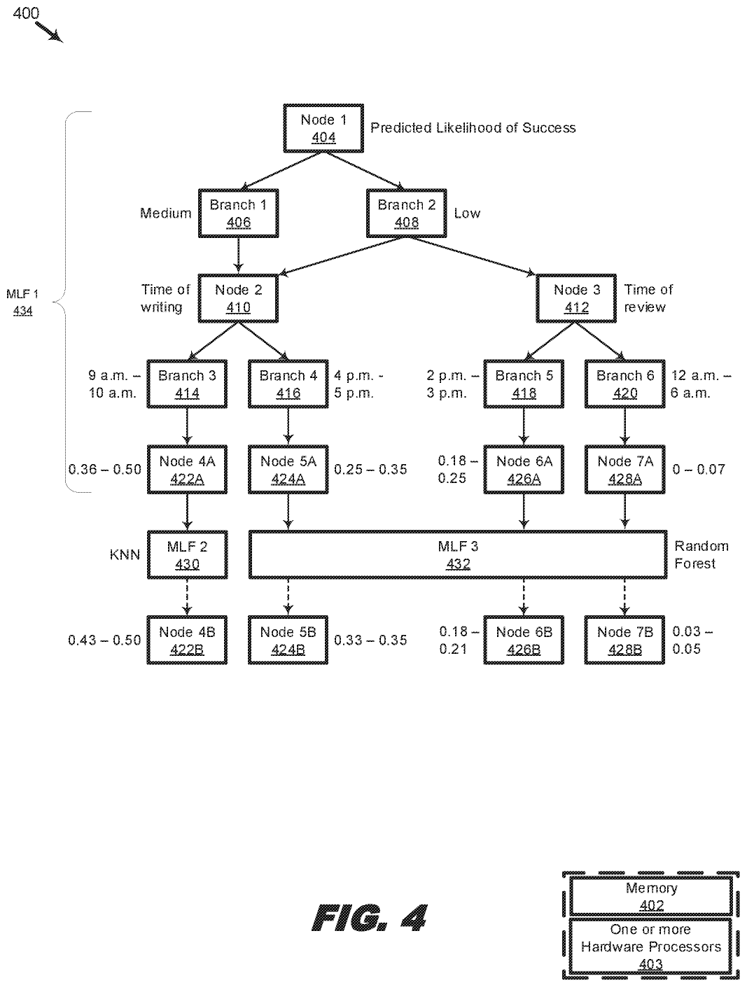

In some examples, a machine learning function may be used to determine the likelihood of success 112 based on the metadata parameters which serve as input into the machine learning function. Such a machine learning function may have been trained with a large number of data sets to accurately predict a likelihood of success 112 from the combination of the input metadata parameters. Refer to FIGS. 3 and 4 for a more detailed description of such machine learning functions.

In some examples, after the analyzer 110 has calculated the predicted likelihood of success 112, a tester 114 tests the source code 106A. In some examples, the test sequence is optimized based on the predicted likelihood of success 112. For instance, if source code 106A has a higher predicted likelihood of success 112 than other source codes, source code 106A may be tested before those other source codes. In some examples, source code 106A may have a predicted likelihood of success 112 that is below a threshold value, resulting in non-testing of source code 106A. For such source codes associated with a below-threshold predicted likelihood of success, further actions may be taken, such as flagging the file containing the source code 106A, alerting the author or the reviewers, generating a notification to other developers, or any other actions that would lead to a corrective action by a relevant party.

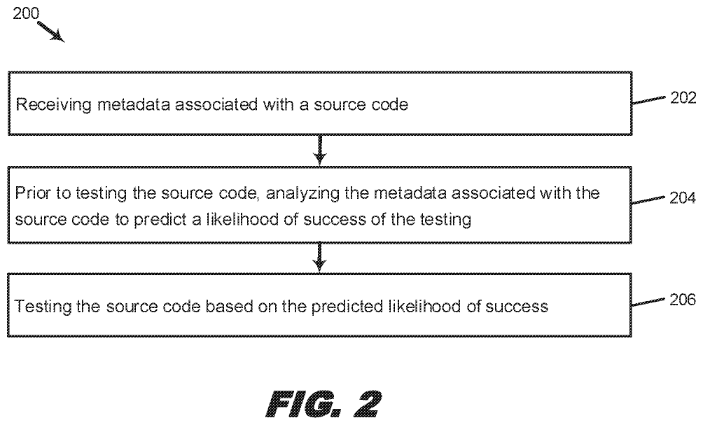

FIG. 2 is a flow diagram illustrating a method for using metadata to predict the likelihood of success of a change involving a piece of source code, in accordance with various examples of the present disclosure. The method 200 may be performed by non-transitory memory and processors provided, for example, by the system 100 described with respect to FIG. 1. Additional steps may be provided before, during, and after the steps of method 200, and some of the steps described may be replaced, eliminated and/or re-ordered for other examples of the method 200. Method 200 may also include additional steps and elements, such as those described with respect to FIGS. 3 and 4. In some examples, method 200 may be performed by one or more computer systems 100 described with respect to FIG. 1, acting in concert or individually.

At action 202, metadata associated with a source code may be received. In some examples, the receiving may be by a computer system including a processor and a memory such as processor 104 and memory 102 described with respect to FIG. 1. The memory may store an analyzer program, such as analyzer 110, to analyze the metadata and to predict the likelihood of success when the source code is tested by a tester. Thus, in some examples, the receiving may be by the analyzer. In some examples, the metadata includes metadata that was included with the source code at the time the source code was retrieved from its source, such as a repository. In some examples, the metadata also includes metadata that was generated by the system or the analyzer by processing the source code or any data or metadata associated with the source code. For example, if the name of the author and the name of the reviewers of the source code are contained in separate files, the system may access the separate files to extract the names as metadata. As a further example, if the number of reviewers is not stored as its own metadata field, the system may also derive the number of reviewers from the names of the reviewers. Thus, the system is able to process the source code and any data or metadata associated with the source code to generate more metadata, which it can use for its analysis.

At action 204, prior to testing the source code, the metadata associated with the source code may be analyzed to predict a likelihood of success of the source code. The analysis may include scoring the metadata parameters as described with respect to FIG. 1, or by machine learning techniques described with respect to FIGS. 3 and 4.

In some examples, the likelihood of success refers to the likelihood of success during testing. Testing may include any kind of software testing, including functional testing, non-functional testing, unit testing, integration testing, system testing, sanity testing, smoke testing, interface testing, beta/acceptance testing, performance testing, load testing, stress testing, volume testing, security testing, system testing, end-to-end testing, white box testing, black box testing, gray box testing, or any other kind of testing. In some examples, the likelihood of success refers to the likelihood of being successfully committed to or merged with a branch in a software development project. In some examples, the likelihood of success refers to the likelihood of being successfully deployed to production or of being successfully executed by an end-user. In some examples, success refers to the absence of any errors including bugs, defects, error codes, error flags, etc. In some examples, success refers to the absence of a specified degree of error. In some examples, success refers to outputting an expected output, or performing according to a developer's or a customer's expectations.

At action 206, the source code may be tested based on the predicted likelihood of success. Action 206 may be preceded by a determination as to whether to test the source code based on the predicted likelihood of success. In some examples, if the predicted likelihood of success is below a threshold value, the source code will not be tested. In some examples, if the predicted likelihood of success is above a first threshold value (e.g., 50%), the source code may be tested. In some examples, if the predicted likelihood of success is above a second, higher, threshold value (e.g., 99%), the source code may not be tested. Such a strategy may be used to conserve the tester's or the system's resources.

If the source code is tested, the source code may be tested based on the predicted likelihood of success. In some examples, the predicted likelihood of success determines the order in which the source codes are tested. For instance, source codes with a higher predicted likelihood of success may be tested before source codes having a lower predicted likelihood of success. In some examples, the predicted likelihood of success determines the rigor with which a source code is tested, such as the number of tests that are run or the complexity of the tests. Thus, source codes having a lower predicted likelihood of success may be more rigorously tested than source codes having a higher predicted likelihood of success. The above descriptions relating to the testing of source code based on a predicted likelihood of success are merely exemplary, and any other usage of a predicted likelihood of success generated by analysis of metadata relating to source code so as to improve a software tester in any way, such as its efficiency, performance or accuracy, is also contemplated.

FIG. 3 is an organizational diagram illustrating a system 300 for generating a predicted likelihood of success using a machine learning function, in accordance with various examples of the present disclosure. The system 300 includes a non-transitory memory 302 and one or more hardware processors 304 coupled to the non-transitory memory 302, which are similar to those described with respect to FIG. 1. In the present example, the one or more hardware processors 304 executes instructions from the non-transitory memory 302 to perform operations for analyzing, by a machine learning function, the metadata associated with the source code to predict a likelihood of success of the source code.

More particularly, FIG. 3 shows a machine learning function based on a decision tree comprising of nodes and branches to classify the metadata. The types of nodes include decision nodes and leaf nodes. At a decision node, a classification is made, resulting in two or more branches being formed. Each branch represents a set of values from the data set. The branches may further be classified using other decision nodes, which in turn spawn more branches. A final classification is reached at a leaf node. Thus, the more classifications are made according to the nodes and branches, the more a data set is broken down into subsets of increasing depth.

The first node in a decision tree may be the best predictor for the data set, and is known as the root node. In some examples, the root node is supplied by a user of the system 300. In some examples, the root node is determined based on the entropy or the information gained by using a particular metadata parameter, or combination of metadata parameters, to classify the data set. The metadata parameter or combination of metadata parameters having the highest entropy or the most information gain may be selected as the root node. For example, referring to FIG. 3, the root node, Node 1, 306, is change type, i.e., whether a change, such as a change that would be introduced by committing or merging the source code in question with other source code or with other files, is functional (Branch 1, 308) or non-functional (Branch 2, 310). Conceptually, change type makes sense as a root node because non-functional changes may be expected to almost always pass testing, while functional changes may be expected to have a low or medium likelihood of passing testing. Whether a change is functional or non-functional may be inferred from the file type, as earlier explained with respect to FIG. 1. Besides file type, other types of metadata may be used to infer if a piece of source code is associated with functional or non-functional changes. The corresponding leaf node, Node 2, 312, confirms the intuition that non-functional changes should have a high predicted likelihood of success. In fact, as a result of this classification, Node 2, 312, indicates at least a “Very High” predicted likelihood of success.

In more detail about the classifications for the predicted likelihood of success, a “Low” predicted likelihood of success may, for example, include predicted likelihoods between 0 and 0.25 inclusive; a “Medium” predicted likelihood of success may, for example, include predicted likelihoods between 0.25 and 0.50 inclusive; a “High” predicted likelihood of success may, for example, include predicted likelihoods between 0.50 and 0.75 inclusive; a “Very High” predicted likelihood of success may, for example, include predicted likelihoods between 0.75 and 1.0 inclusive. In some examples, data sets are classified according to a lowest common denominator. Thus, a “Medium” predicted likelihood of success may mean at least a “Medium” predicted likelihood of success, i.e., a “Low” likelihood of success may refer to a likelihood of success of at least 0 and up to 0.25 inclusive; a “Medium” likelihood of success may refer to a likelihood of success greater than 0.25; a “High” likelihood of success may refer to a likelihood of success greater than 0.5; a “Very High” likelihood of success may refer to a likelihood of success greater than 0.75. The name, number, range, and cutoff values of the predicted likelihood of success categories are all exemplary only and may be changed to suit the intended application.

Returning to the example, let us assume that the analysis of the metadata corresponding to the source code reveals that the corresponding source code is not of a non-functional change type, but is instead of a functional change type (Branch 2, 310). To further break down the metadata, a first decision node, Node 3, 314, may be used.

In this example, the first decision node, Node 3, 314, categorizes the metadata in Branch 2, 310 according to the number of lines of the source code and the number of files associated with the source code (e.g., packaged dependencies). These metadata parameters may have been specifically selected to serve as the first decision node based on their high entropy and information gain. In some examples, such as in this one, several metadata parameters may be combined to increase the entropy or information gain of the node. In some examples, the metadata parameter or combination of metadata parameters with the highest entropy or information gain is used as the root node, the second-highest metadata parameter or combination of metadata parameters is used as the first decision node, the third-highest metadata parameter or combination of metadata parameters is used as the second decision node, so on and so forth.

Branch 3, 316, and Branch 4, 318, show specifically how the parameters in the preceding node (Node 3, 314) have been used to further break the data set down. In this example, the metadata is broken down into two further categories based on whether the metadata reveals that the corresponding source code is not only of a functional type, but has more than 200 lines and is associated with more than 50 files. Thus, the first further category includes metadata corresponding to functional source code having more than 200 lines and associated with more than 50 files, while the second further category includes metadata corresponding to functional source code having less than 200 lines and associated with less than 50 files. The precise number of lines and number of files that delineate between the two categories may be determined based on the entropy or information gained by combining X number of lines with Y number of files, and varying X and Y until a maximum value is reached, similar to how the root node and the subsequent decision nodes may be determined. As a result of this further classification, the corresponding leaf node, Node 5, 322, indicates a “High” predicted likelihood of success for functional source code having less than 200 lines and associated with less than 50 files. However, in the interest of further developing the example, let us assume that the analysis of the metadata corresponding to the source code reveals that the corresponding source code has, in fact, more than 200 lines and an association with more than 50 files (Branch 3, 316). To further break down the data set, a second decision node, Node 4, 320, may be used.

The second decision node, Node 4, 320, categorizes the metadata in Branch 3, 316, according to author experience and the number of reviewers. Branch 5, 324, and Branch 6, 326, show the specific values of the data parameters in the preceding node (Node 4, 320) used to further break the data set down. In this example, the metadata is broken into two further categories. The first further category includes functional source code that not only has more than 200 lines and an association with more than 50 files, but is also written by authors having less than 102 commits and reviewed by less than 2 reviewers. The second further category includes functional source code that not only has more than 200 lines and an association with more than 50 files, but is also written by authors having more than 102 commits and reviewed by more than 2 reviewers. The precise numbers of author commits and reviewers that delineate between the two categories may be determined based on entropy and information gain. As a result of this further classification, the corresponding leaf node, Node 7, 330, indicates a “Medium” predicted likelihood of success in the latter category. However, in the interest of further developing the example, assume that the metadata of the source code being analyzed shows that the source code is written by authors having less than 102 commits and reviewed by less than 2 reviewers. To further break down the data set, a third decision node, Node 6, 328, may be used.

The third decision node, Node 6, 328, categorizes the functional source code in Branch 5, 324, according to file type. Branch 7, 332, and Branch 8, 334, show the specific values of the data parameters in the preceding node (Node 6, 328) used to further break the data set down. In this example, the metadata is broken into two further categories. The first further category includes functional source code that not only has the features of metadata in Branch 5, 324, but is also of a “code” file type previously described with respect to FIG. 1. The second further category includes functional source code that not only has the features of metadata in Branch 5, 324, but is also of a “config” file type previously described with respect to FIG. 1. The specific file types used to further categorize the metadata may be determined based on entropy and information gain. As a result of this further classification, the corresponding leaf node, Node 8, 336, indicates a “Low” predicted likelihood of success of the source code if its associated metadata further reveals that the source code or the files associated with the source code (e.g., the files packaged together with the source code as part of a commit) are of the “code” file type. However, if the metadata corresponding to the source reveals that the source code or the files associated with the source code (e.g., the files packaged together with the source code as part of a commit) are of the “config” file type, the corresponding leaf node, Node 9, 338, indicates a “Medium” predicted likelihood of success of the source code.

The metadata parameters used in this example are for illustrative purposes only. Any other type of data, not just metadata, may be used as nodes and branches. For simplicity, a limited number of branches and nodes are shown in FIG. 3. Any number of nodes and branches, any number of branches per node, and any number of nodes per branch, may be used to categorize the data in the decision tree. Further, any other desired result of the classification, not just a predicted likelihood of success, may be used as leaf nodes. Additionally, FIG. 3 uses a decision tree for classification, any other type of machine learning function or model may be used to further classify any data and to predict any outcome, including classifying metadata and predicting a likelihood of success of source code corresponding to the metadata.

FIG. 4 is an organizational diagram illustrating a system 400 for generating a further predicted likelihood of success using additional machine learning functions, in accordance with various examples of the present disclosure. The system 400 includes a non-transitory memory 402 and one or more hardware processors 403 coupled to the non-transitory memory 402, which are similar to those described with respect to FIG. 1. In the present example, the one or more hardware processors 403 executes instructions from the non-transitory memory 402 to perform operations for analyzing, by a machine learning function, the metadata associated with the source code to predict a likelihood of success of the source code. System 400 may be used in conjunction with system 300 described with respect to FIG. 3.

More particularly, FIG. 4 shows additional machine learning functions being used to further analyze metadata corresponding to source code that has been determined to have a low or medium predicted likelihood of success. For example, the metadata in the leaf nodes marked “Low” or “Medium” in FIG. 3 may be further analyzed using a first machine learning function, MLF 1, 434. MLF 1 may be a decision tree including nodes and branches, similar to the decision tree described with respect to FIG. 3.

The root node, Node 1, 404, may classify metadata according to the predicted likelihood of success. For example, metadata corresponding to source code having a “Medium” likelihood of success may be classified under Branch 1, 406, and metadata corresponding to source code having a “Low” likelihood of success, may be classified under Branch 2, 408.

The metadata in Branch 1, 406, and Branch 2, 408, may further be analyzed based the time of writing (Node 2, 410) and the time of review (Node 3, 412). In some examples, the metadata corresponding to source code having at least a “Medium” likelihood of success in Branch 1, 406, may be further analyzed according to the time of writing (Node 2, 410) only, while the metadata corresponding to source code having at least a “Low” likelihood of success in Branch 2, 408, may be further analyzed according to both the time of writing (Node, 2, 410) and the time of review (Node 3, 412). The time of writing, may, for example, be the time that an author last saved the file containing the source code, and the time of review, may, for example, be the time that a reviewer entered his last comments concerning the source code. Other examples of the time of writing and the time of review have earlier been described with respect to FIG. 1.

Following Branch 1, 406, and Node 2, 410, metadata corresponding to source code having at least a “Medium” likelihood of success may further be classified under Branch 3, 414, if the time of writing was between 9 a.m. and 10 a.m., or under Branch 4, 416, if the time of writing was between 4 p.m. and 6 p.m. As with other parameters, the specific times (e.g., 9 a.m.-10 a.m., and 4 p.m.-6 p.m.) used to classify the metadata in Node 2, 410, may be determined based on entropy and information gain. While only two branches and two times are shown here for ease of discussion, any number of branches and times could be used for further classification.

Based on the further classification, metadata corresponding to source code having at least a “Medium” likelihood of success and which (source code) was written between 9 a.m. and 10 a.m. may be categorized under a narrower likelihood range within the “Medium” category. As described with respect to FIG. 3, the “Medium” category may include a predicted likelihood of success between 0.25 and 0.50 inclusive. In this example, the predicted likelihood of success of the source code corresponding to the metadata in Branch 3, 414, i.e., source code that has a “Medium” predicted likelihood of success and which was written between 9 a.m. and 10 a.m., is 0.36-0.50 as shown in Node 4A, 422A. Thus, the further classification has resulted in a narrower range of the predicted likelihood of success, from 0.25-0.50 (i.e., “Medium”) to 0.36-0.50 in this case.

Similarly, the predicted likelihood of success of the source code corresponding to the metadata in Branch 4, 416, i.e., source code that has a “Medium” predicted likelihood of success and which was written between 4 p.m. and 5 p.m., is 0.25-0.35 as shown in Node 5A, 424A. Again, the further classification has resulted in a narrower range of the predicted likelihood of success, from 0.25-0.50 (i.e., “Medium”) to 0.25-0.35 in this case.

Following Branch 2, 408, and Node 2, 410, metadata corresponding to source code having at least a “Low” likelihood of success may similarly further be classified under Branch 3, 414, if the time of writing was between 9 a.m. and 10 a.m., or under Branch 4, 416, if the time of writing was between 4 p.m. and 6 p.m. As with other parameters, the specific times (e.g., 9 a.m.-10 a.m., and 4 p.m.-6 p.m.) used to classify the metadata in Node 2, 410, may be determined based on entropy and information gain. While only two branches and two times are shown here for ease of discussion, any number of branches and times could be used for further classification.

Based on the further classification, metadata corresponding to source code having at least a “Low” likelihood of success and which (source code) was written between 9 a.m. and 10 a.m. may be categorized under a narrower likelihood range within the “Low” category. As described with respect to FIG. 3, the “Low” category may include a predicted likelihood of success between 0 and 0.25 inclusive. In this example, the predicted likelihood of success of the source code corresponding to the metadata in Branch 4, 416, i.e., source code that has a “Low” predicted likelihood of success and which was written between 9 a.m. and 10 a.m., is 0.20-0.25 (node not shown). Thus, the further classification has resulted in a narrower range of the predicted likelihood of success, from 0-0.25 (i.e., “Low”) to 0.20-0.25 in this case. Similarly, the predicted likelihood of success of the source code corresponding to the metadata in Branch 4, 416, i.e., source code that has a “Low” predicted likelihood of success and which was written between 4 p.m. and 5 p.m., is 0.10-0.20 (node not shown). Again, the further classification has resulted in a narrower range of the predicted likelihood of success, from 0-0.25 (i.e., “Low”) to 0.10-0.20 in this case.

Returning to Branch 2, 408, and Node 3, 412, metadata corresponding to source code having at least a “Low” likelihood of success may further be classified under Branch 5, 416, if the time of review was between 2 p.m. and 3 p.m., or under Branch 6, 420, if the time of review was between 12 a.m. and 6 a.m. As with other parameters, the specific times (e.g., 2 p.m.-3 p.m., and 12 a.m.-6 a.m.) used to classify the metadata in Node 3, 412, may be determined based on entropy and information gain. While only two branches and two times are shown here for ease of discussion, any number of branches and times could be used for further classification.

Based on the further classification, metadata corresponding to source code having at least a “Low” likelihood of success and which (source code) was reviewed between 2 p.m. and 3 p.m. may be categorized under a narrower likelihood range within the “Low” category. As described with respect to FIG. 3, the “Low” category may include a predicted likelihood of success between 0 and 0.25 inclusive. In this example, the predicted likelihood of success of the source code corresponding to the metadata in Branch 5, 418, i.e., source code that has a “Low” predicted likelihood of success and which was reviewed between 2 p.m. and 3 p.m., is 0.18-0.25 as shown in Node 6A, 426A. Thus, the further classification has resulted in a narrower range of the predicted likelihood of success, from 0-0.25 (i.e., “Low”) to 0.18-0.25 in this case. Similarly, the predicted likelihood of success of the source code corresponding to the metadata in Branch 4, 416, i.e., source code that has a “Low” predicted likelihood of success and which was reviewed between 12 a.m. and 6 a.m., is 0-0.07 as shown in Node 7A, 428A. Again, the further classification has resulted in a narrower range of the predicted likelihood of success, from 0-0.25 (i.e., “Low”) to 0-0.07 in this case.

Further classification may be performed by additional machine learning functions, such as machine learning function (MLF) 2, 430, and MLF 3, 432. While two additional MLFs are shown, any number and any type of additional MLFs may be used to perform the further classification. In some examples, MLF 2, 430, and MLF 3, 432, may be different from MLF 1. In some examples, MLF 2, 430, and MLF 3, 432, are more resource-intensive than MLF 1, 434. More resource-intensive MLFs may be more thorough, make less assumptions, and more accurate than less resource-intensive MLFs. Thus, it may be desirable to further analyze the results of MLF 1, 434, using MLF 2, 430, and/or MLF 3, 432. In some examples, MLF 2, 430, and MLF 3, 432, may be more accurate or more capable of fine categorization than MLF 1, 434. In some examples, MLF 3, 432, is more resource-intensive, accurate, or capable of fine categorization than MLF 2, 430, or vice versa. By using additional MLFs with different strengths and capabilities, the results of MLF 1, 434, may be analyzed in an efficient yet accurate way.

For example, metadata associated with source codes having a predicted likelihood of success associated with a first threshold may be further analyzed by MLF 2, 430, having a medium resource-intensity, such as K nearest neighbors, while metadata associated with source codes having a predicted likelihood of success associated with a second threshold may be further analyzed by MLF 3, 432, having a high resource-intensity, such as random forest. As an example, the threshold associated with MLF 2, 430, is 0.36. Such a threshold value is exemplary only, as any value may be used as the threshold. In some examples, the threshold includes a lower threshold and a higher threshold, i.e., a band. In some examples, the threshold value is determined by entropy and information gain similar to determining cut-off points for branches. Thus, MLF 1 may determine, based on entropy or information gain, what the threshold value should be in order to qualify for analysis by each additional MLF. Such threshold value may change from time to time as more data is received by the MLFs causing the entropy or information gain of the data to change even when the same threshold value is used. As such, maximum entropy or information gain may correspond to a different value, which in some examples, will be set as the new threshold value. Accordingly, at time T1, the threshold associated with MLF 2, 430, may be a first value (e.g., 0.40), and the threshold associated with MLF 3, 432, may be a second value (e.g., 0.20); but with different data at another time T2, the threshold associated with MLF 2, 430, may change from the first value (e.g., 0.40) to a third value (e.g., 0.35), and the threshold associated with MLF 3, 432, may change from the second value (e.g., 0.20) to a fourth value (e.g., 0.60).

Returning to FIG. 4 and assuming that the threshold value is currently 0.36 as shown, then metadata associated with source codes having a predicted likelihood of success above 0.36 may be further analyzed by MLF 2, 430. Other MLFs, such as MLF 3, 432, may analyze metadata associated with source codes having a predicted likelihood of success at or below 0.36. Notice that the predicted likelihood of success of source code associated with metadata in Node 4A, 422A, is 0.36-0.50, which is above the 0.36 threshold. Thus, the metadata in Node 4A, 422A may be further analyzed by MLF 2, 430. In contrast, the predicted likelihoods of success of the source code or codes associated with metadata in Node 5A, 422A, Node, 6A, 426A, and Node 7A, 428A are all below the 0.36 threshold. Thus, the metadata in Node 5A, 422A, Node, 6A, 426A, and Node 7A, 428A may not be further analyzed by MLF 2, 430.

Nevertheless, the metadata in Node 5A, 422A, Node, 6A, 426A, and Node 7A, 428A may be further analyzed by MLF 3, 432, because the threshold associated with MLF 3, 432, is below 0.36. Specifically, the predicted likelihoods of success of the source code or codes associated with metadata in Node 5A, 422A, Node, 6A, 426A, and Node 7A, 428A are 0.25-0.35; 0.18-0.25; and 0-0.07 respectively, all of which are below the 0.36 threshold.

As a result of the further analysis under MLF 2, 430, the predicted likelihood of success of source code corresponding to metadata in Node 4A, 422A, has been narrowed down from 0.36-0.50 (Node 4A, 422A) to 0.43 to 0.50 (Node 4B, 422B). Thus, the predicted likelihood of success of source code corresponding to metadata in Node 4A improved.

Similarly, as a result of the further analysis under MLF 3, 432, the predicted likelihood of success of source code corresponding to metadata in Node 5A, 424A was narrowed down from 0.25-0.35 (Node 5A, 424A) to 0.33-0.35 (Node 5B, 424B). Thus, the predicted likelihood of success of source code corresponding to metadata in Node 5A improved.

Further, as a result of the further analysis under MLF 3, 432, the predicted likelihood of success of source code corresponding to metadata in Node 6A, 426A was narrowed down from 0.18-0.25 (Node 6A, 426A) to 0.18-0.21 (Node 6B, 426B). Thus, the predicted likelihood of success of source code corresponding to metadata in Node 6A improved.

Finally, as a result of the further analysis under MLF 3, 432, the predicted likelihood of success of source code corresponding to metadata in Node 7A, 428A was narrowed down from 0-0.07 (Node 7A, 428A) to 0.03-0.05 (Node 7B, 428B). Thus, the predicted likelihood of success of source code corresponding to metadata in Node 7A improved.

The resultant narrower ranges of the predicted likelihoods of success allow the system 400 to make better decisions as to whether to test or to send the source codes for testing. For example, if the decision to test or send for testing is based on a predicted likelihood of success score of 0.4 or higher, then the source code corresponding to the metadata analyzed at Node 4A, 422A, would not be tested or sent for testing because its predicted likelihood of success is 0.36-0.50 and thus below the threshold. However, by the additional analysis of MLF 2, 430, the predicted likelihood of success of the same source code increased to 0.43-0.50 (Node 4B, 422B), which is above the 0.4 threshold. Thus, the correct decision would be to test or send the source code for testing. In addition, a false negative (i.e., wrong rejection of a source code for testing) was prevented, which saves both the author and the reviewer's time and effort in reviewing the code for errors.

Another exemplary advantage of the narrower ranges is in reducing the generation of false alarms. For example, if the threshold for generating a message to a reviewer to perform further review is 0.3 or below, then source code corresponding to metadata analyzed at Node 5A, 424A would have triggered a review message because the likelihood of success predicted by MLF 1, 434, was 0.25-0.35 as shown in Node 5A, 424A. However, after further analysis by MLF 3, 432, the predicted likelihood of success was improved to 0.33-0.35 (Node 5B, 424B), putting the predicted likelihood of success above the 0.3 threshold. As a result, the review message would not be sent, reducing the generation of false positives and saving the reviewers' precious time.

Thus, further analysis generating narrower ranges may be used to reduce the generation both of false positives and false negatives, which allows testing to proceed more efficiently and allows authors and reviewers to focus their time and effort only on truly erroneous code.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure. Although illustrative examples have been shown and described, a wide range of modification, change and substitution is contemplated in the foregoing disclosure and in some instances, some features of the examples may be employed without a corresponding use of other features. In some instances, actions may be performed according to alternative orderings. One of ordinary skill in the art would recognize many variations, alternatives, and modifications. Thus, the scope of the invention should be limited only by the following claims, and it is appropriate that the claims be construed broadly and in a manner consistent with the scope of the examples disclosed herein.

1. A method comprising:
receiving metadata associated with a source code;
prior to testing the source code, analyzing the metadata associated with the source code to predict a likelihood of success of the testing; and
testing the source code based on the predicted likelihood of success.

2. The method of claim 1, wherein the predicted likelihood of success is based only on the analysis of the metadata.

3. The method of claim 2, wherein the predicted likelihood of success is not based on content directly contained in the source code.

4. The method of claim 2, wherein the predicted likelihood of success is not based on an analysis of any function or operation contained in the source code.

5. The method of claim 1, wherein the metadata includes at least one parameter selected from the group consisting of: author name; author experience; reviewer name; number of reviewers; and reviewer experience.

6. The method of claim 1, wherein the predicted likelihood of success is determined based on metadata including at least one parameter selected from the group consisting of: author name; author experience; reviewer name; number of reviewers; and reviewer experience.

7. The method of claim 1, wherein the metadata used to predict the likelihood of success is includes at least one parameter selected from the group consisting of: file extension; type of change; total number of lines of code changed; and reviewer's sentiment.

8. The method of claim 1, wherein the metadata used to predict the likelihood of success is includes at least one parameter selected from the group consisting of: time of writing; and time of review.

9. The method of claim 1, wherein the metadata used to predict the likelihood of success is includes at least one parameter selected from the group consisting of: number of testing failures associated with the source code; and reason for failure.

10. The method of claim 1, further comprising categorizing the source code as associated with a code change or not associated with a code change based on a file extension associated with the source code.

11. The method of claim 1, wherein the analyzing includes selecting, by a machine learning function, a combination of metadata parameters from the metadata based on an accuracy with which the combination of metadata parameters correctly predicts a testing result of previously tested source code.

12. The method of claim 11, wherein the analyzing the metadata is based on the selected combination of metadata parameters.

13. The method of claim 12, wherein the predicted likelihood of success includes one or more categories indicative of the predicted likelihood of success.

14. The method of claim 13, wherein further analysis is performed, the further analysis comprising:
determining, based on the predicted likelihood of success and an association of the source code with the one or more categories, to perform further analysis of the metadata;
choosing, by the machine learning function, additional metadata parameters used in the further analysis based on an accuracy with which the combination of the selected metadata parameters and the additional metadata parameters correctly predicts a testing result of previously tested source code; and
further analyzing the metadata associated with the source code based on the combination of the selected metadata parameters and the chosen additional metadata parameters.

15. The method of claim 14, wherein the machine learning function includes a decision tree function, a K nearest neighbors function, or a random forest function.

16. The method of claim 14, wherein the further analyzing includes using a first machine learning function to further analyze a first predicted likelihood of success category, and using a second, more computationally-intensive machine learning function to further analyze a second predicted likelihood of success category, wherein the second predicted likelihood of success category is indicative of a lower predicted likelihood of success than the first predicted likelihood of success category.

17. The method of claim 15, wherein source code associated with the first predicted likelihood of success category or the second predicted likelihood of success category is recategorized to a different predicted likelihood of success category as a result of the further analysis.

18. A system comprising:
a non-transitory memory; and
one or more hardware processors coupled to the non-transitory memory to execute instructions from the non-transitory memory to perform operations comprising:
receiving metadata associated with a source code;
prior to testing the source code, analyzing the metadata associated with the source code to predict a likelihood of success of the testing;
ranking the source code based on the predicted likelihood of success; and
testing the source code based on the ranking.

19. The system of claim 17, wherein the likelihood of success is based only on the analysis of the metadata.

20. A non-transitory machine-readable medium having stored thereon machine-readable instructions executable to cause at least one machine to perform operations comprising:
receiving metadata associated with a source code;
prior to testing the source code, analyzing the metadata associated with the source code to predict a likelihood of success of the testing;
determining not to test the source code based on the predicted likelihood of success;
further analyzing the metadata using a machine learning function to generate a narrower likelihood range of the predicted likelihood of success; and
determining to test the source code based on the narrower likelihood range.
